(19) United States
(12) Patent Application Publication
(10) Pub. No.: US 2014/0297021 A1
(43) Pub. Date: Oct. 2, 2014

(54) HIGH SPEED POCKET MILLING OPTIMISATION

(71) Applicants: Saurabh Aggarwal, Lausanne (CH); Sandeep Dhanik, Lanzburg (CH); Paul Xirouchakis, St-Sulpice (CH)

(72) Inventors: Saurabh Aggarwal, Lausanne (CH); Sandeep Dhanik, Lanzburg (CH); Paul Xirouchakis, St-Sulpice (CH)

(73) Assignee: ECOLE POLYTECHNIQUE FEDERALE DE LAUSANNE (EPFL), Lausanne (CH)

(21) Appl. No.: 13/984,634

(22) PCT Filed: Feb. 13, 2012
(86) PCT No.: PCT/EP12/52424

§ 371 Date: Oct. 17, 2013

(30) Foreign Application Priority Data
Feb. 11, 2011 (EP) 11154120.7

(51) Int. Cl. G05B 19/402

(52) U.S. Cl. CPC G05B 19/402
USPC 700/160

(57) ABSTRACT

The invention relates to a method of toolpath generation and cutting parameters optimization for high speed milling of a convex pocket, wherein said method comprises a first sub-method of generating a toolpath and a second sub-method of generating optimized chatfree cutting parameters using a genetic algorithm wherein the first sub-method generates milling toolpaths that minimize the radial depth of cut variations as well as the curvature change variations while avoiding leftover material at the corners, wherein said toolpaths automatically avoid self-intersecting features encountered during the offsetting of pocket boundary such that the said toolpaths result in reduction in milling time for a given maximum acceptable radial depth of cut and wherein said second sub-method allows the free choice of cutting parameters and optimizes the milling time and wherein the optimization method incorporates relevant milling constraints as milling stability constraint, cutting forces, machine-tool and cutting tool capabilities.

### RELATED APPLICATION

The present application claims priority to earlier EP application No 11154120.7 filed on Feb. 11, 2011 in the name of the same applicant, the content of which is incorporated in its entirety in the present application.

### BACKGROUND OF THE INVENTION

The introduction of high-speed machining (HSM) in the current practice of milling promises great benefits in productivity and part quality. However, the optimal use of this relatively new technology is sometimes hampered by chatter vibrations which may damage the tool, the work piece or even may cause wear and tear on the spindle. Although a lot of progress has been performed in the past decades in studying and better understanding of the chatter problem and the factors that influence it, there is still a practical need to bring to the shop floor some tools that will assist process planners in their part programming to avoid chatter vibrations while using the full potential of the machine tool system.

Europe has a great number of milling companies that use the HSM technology for various applications such as the machine construction and in the aeronautics and aerospace industries. A survey of machining industries was recently conducted in order to find out:

(i) the most important problems encountered today during the milling of parts and

(ii) the needed simulation and part programming functionalities.

The response obtained from the survey demonstrates that the problem of chatter during metal cutting is experienced by most of the manufacturers. At present manufacturers mainly go with cutting trials for setting appropriate cutting parameters which consumes both time and money and thus raises their production cost. Furthermore, they use lower values of spindle speeds and/or feeds per tooth which lowers the productivity.

The commercial CAM (Computer Aided Manufacturing) packages available in the market do not provide the complete part programming functionalities. Through the inclusion of advance milling simulation and part programming functionalities expected gains are clear in terms of; improved part quality, machine productivity and cost-savings.

Currently part programs are generated with a long overall preparation time and with rather “slow” machining time performance in terms of fully exploiting the available machine tool system capabilities. This is so, since current CAM software do not offer guidance in selecting the appropriate axial and radial depths of cuts and associated spindle speeds to avoid the occurrence of chatter vibrations; as a result, these choices must rely solely on the experience and intuition of the part programmer Consequently, in current practices the part programmer must make the majority of process planning decisions such as the selection of the toolpath geometry, the cutting direction, the number of axial passes and the corresponding axial and radial depths of cuts, the cutting speeds and feed per tooth without computer aided support in quantifying the dynamics of the machine tool/spindle/tool holder/cutting tool system interactions. Therefore, long preparation times are experienced in order to try to avoid the occurrence of chatter vibrations with iterative trial-and-error verification cuts. The resulting process plans are rather “slow” i.e. they result in a long machining time. Furthermore, chatter vibrations are not always avoided which may significantly reduce the tool life and as a consequence the overall machining productivity.

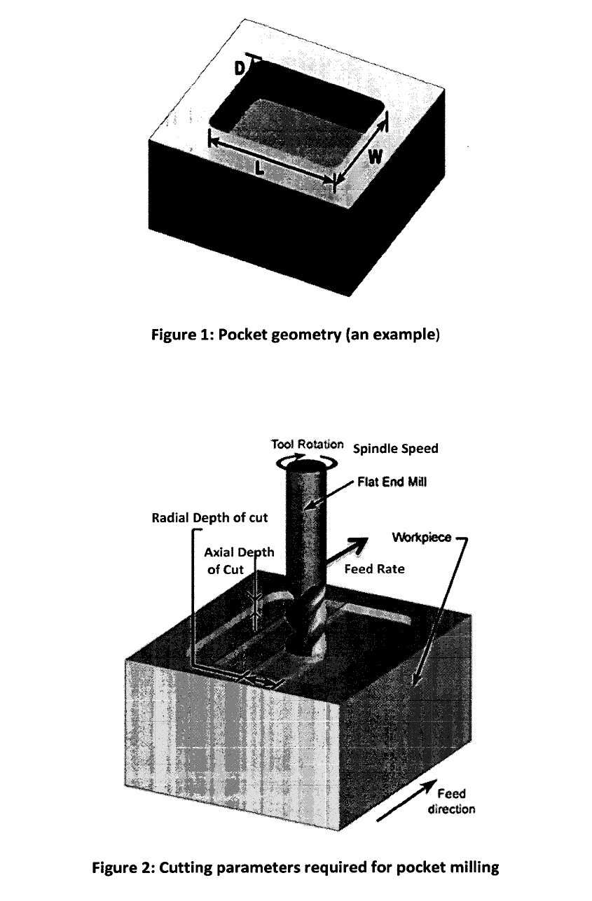

Pocket milling is one of the most common operations in machining industry. Nearly 80% of the milling operations to machine mechanical parts are produced by NC pocket milling operation using flat end mill [Held, 2001]. A 2.5 D pocket is defined by closed curve and depth as shown in FIG. 1 with the parameters length (“L”), width (“W”) and depth (“D”).

Generally the pocket is generated by sweeping a cylindrical tool inside the pocket boundary with a predefined toolpath. CAD/CAM systems are used for the toolpath trajectory generation using geometrical parameters, axial and radial depth of cut for specified boundary and depth of the pocket. To move along the trajectory of the toolpath spindle speed and feed rate are required. In a nutshell, for complete part program for pocket milling, the following parameters are required: spindle speed, axial depth of cut, radial depth of cut and feed rate and corresponding toolpath geometry. These parameters are presented in FIG. 2.

In current manufacturing practice cutting parameters are selected based on part programmer experience and guidelines specified by cutting tool catalogues and the cutting toolpaths are generated using existing CAD/CAM systems.

However the following main problems are often encountered during pocket milling operation:
Machine tool system vibration known as chatter
Interruption due to violation of machine tool power and/or feed rate limits
Tool breakage and/or excessive wear
High fluctuation of cutting forces along the toolpath

These problems lead to poor surface finish, machine tool damage, work piece damage, excessive noise, repetition of trials and unwanted waste. Due to the above mentioned problems, the part programs need to be verified iteratively using trial and error experiments. This leads to long preparation time and rather slow machining time performance in terms of fully exploiting machine tool capabilities.

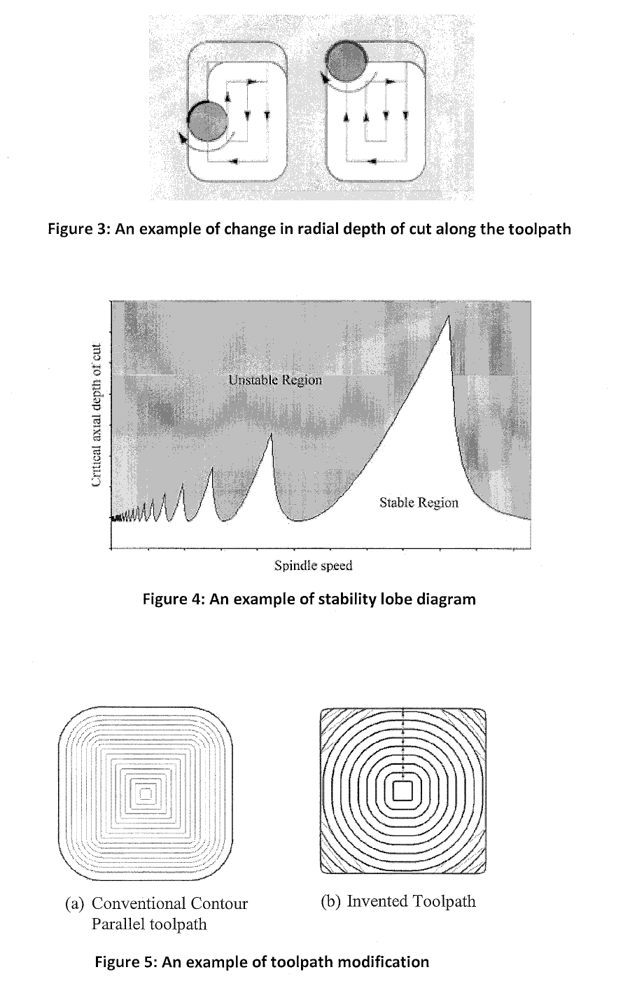

The above mentioned problems are encountered due to two main reasons which are detailed as following:
1. Cutting parameters related issues:
   One of the major causes of the above mentioned problems is due to the unavailability of machine tool dynamic information at part programming level. Even with experienced users, the selection of cutting parameters does not ensure the stability of the milling process as the system dynamics change significantly for every variant of machine tool/spindle/tool holder/tool work piece material system. Other causes that may lead to problem during milling are violation of machine tool specification (Power, torque and feed limits) and cutting tool specification (allowable cutting force and deflections).
2. Toolpath generation related issues:
   Toolpath generation by using existing CAD/CAM system is purely geometric in nature and devoid of physical phenomena due to tool work piece contact during milling process. For example, these toolpath are highly susceptible for change in radial depth of cut along the toolpath as shown in FIG. 3, which leads to fluctuation in cutting forces and may violate the stability limit. Moreover the sharp corners in the toolpath geometry are detrimental for machine tool kinematics and limits stepover value.

In order to improve existing part program, it is required to consider machine tool system dynamics & its capabilities and toolpath generation with minimum variation of radial depth of cut along the toolpath.

Also, in order to ensure stability during pocket milling, cutting parameters must respect stability limits for a specified machine tool/spindle/tool holder/tool and work piece material system at a given radial depth of cut. Stable cutting parameters can be selected from stability lobe diagram. The stability lobe diagram is the border between a stable cut (chatter free) and an unstable cut (chatter) as shown in FIG. 4.

Stability lobe diagram can be generated from the frequency response (FRF) function measured at cutting tool tip for a specified machine tool/spindle/tool holder/tool, cutting force coefficients, cutting tool specifications and at fixed radial depth of cut [Altintas and Budak 1995].

Cutting power and torque are functions of cutting parameters and work piece material. Cutting parameters should be selected in a way to respect the machine tool power and torque limits To ensure the tolerances of the pocket boundary, cutting tool deflection should also be considered during the selection of cutting parameters.

Further, toolpath geometry must be modified in order to ensure:

(i) minimum variation in radial depth of cut along the toolpath in order to ensure uniformity of physical phenomena in cutting process

(ii) smoothness of toolpath along contour cutting in order to avoid sharp corners, which leads to high machine kinematic performance.

An example of the modified toolpaths determined with the method of the invention is given in FIG. 5(b). More specifically, a conventional toolpath is shown in FIG. 5(a), where it can be seen that at each cutting level (each contour) there are sharp corners, which also leads to change in radial depth of cut as seen in FIG. 3 with the mentioned disadvantages.

The toolpath can be generated in a way shown in FIG. 5(b), which significantly reduces number of sharp corners and also maintains uniform offsetting between the consecutive contours according to the present invention.

However, in practice even if the cutting parameters and the toolpath are selected in the way defined above, the overall process plan does not guarantee to be optimized for machining time i.e. which is productivity. There can be number of solutions that are feasible but they do not guarantee the minimum machining time for pocket milling

The machining time can be significantly reduced if both toolpath geometry and the cutting parameters are selected in such a way that takes into account the abovementioned solution with in the optimization problem.

Hence, the present invention proposes an optimization method considering both toolpath and cutting parameters simultaneously.

In current optimization problems, there are four cutting parameters (spindle speed (n), feed rate (fₜ), axial depth of cut (Aₚ) and radial depth of cut (Aₑ)) which makes the search space of the optimization problem huge.

Further, these parameters have complex non-linear relationship with constraints like machine power, torque and stability of milling process. Other important constraints that are essential to consider are cutting tool deflection and cutting tool breaking strength.

### PRIOR ART

As mentioned above, pocket milling is one of the most common operations in machining domain. According to a survey, 80% of the milling operations to machine mechanical parts are produced by NC pocket milling operation using flat end mill [Held, 2001]. For milling a pocket, a process planner is often responsible for the selection of the cutting parameters and the pocketing toolpath with the help of cutting tool database and the standard CAD/CAM software. In CAD/CAM software, one of the first and most popular toolpath generation methods produces toolpath by geometrically offsetting the pocket boundary, which leads to corners at various segments of toolpath. The conventional offsetting to produce toolpath in this manner has the following drawbacks:

(i) Generation of corner points (tangent discontinuity points) even for offsetting of smooth pocket boundary.

(ii) Restriction on stepover value between two successive contours due to uncut material left at sharp corners [Zhao et al., 2007].

The generation of corners affect both machine tool kinematics (rapid change in feed rate) and process related aspect (sudden fluctuation in cutting force, vibration, fast wearing of cutting tool due to thermal fluctuation), while the restriction over stepover reduces the efficiency of milling process drastically. In order to avoid some of the detrimental effects of corners, internal loops are fixed at each level of offsetting which removes material at corners in an incremental manner. In literature, the methods developed show the applications of corner loops are shown for limited type of corners or number of loops [Choy and Chan, 2003].

Another type of corner looping toolpaths, where loops are added external to the corners, although removes restriction on stepover (point (ii)), however leads high variation of radial depth of cut and reverse mode of milling along the toolpath contour [Zhao et al. 2007].

The control over radial depth of cut is presented and existing toolpaths are modified [Coleman and Evan 2010].

Laplace based iterative method for smooth toolpath generation with smooth change in radial depth of cut along the toolpath is also studied [Bieterman and Sandstrom 2003].

Further, trochoidal like milling strategies have been formulated which maintains radial depth of cut below specified upper limit while tool disengage and reengage with work piece material [Coleman et al. 2005].

It can be concluded that the above-mentioned toolpath generation methods although improving toolpath for milling process, do not sufficiently address the main drawbacks specified in point (i) and point (ii) mentioned above.

Hence, the toolpaths need to be modified for the uniform radial depth of cut without any restriction on stepover and also require least number of sharp corner points along the toolpath contour.

Further, the determination of optimal cutting parameters for an assigned cutting tool has a vital role in process planning of metal parts as the economy of machining operations plays an important role in increasing productivity and competitiveness. In shop floors the selection of these parameters is partly left to the process planner and to the tool manufacturer guidelines available in the catalogues. Due to the lack of knowledge about machine-tool dynamic behaviour these guidelines do not ensure the selection of optimal or near optimal cutting parameters.

There are numerous methods to solve optimization problems but there is no efficient all-purpose optimization method available. Some methods produce accurate solutions by making rigorous computations which is not computationally economical in terms of time and cost. Some models develop solutions closer to the optimum in a fast manner Therefore, a compromise between the high accuracy of a rigorous solution and lower accuracy of a computationally efficient method has to be made. With the use of Genetic algorithm (GA), the impact and the power of the artificial techniques have been reflected on the performance of the optimization system.

Genetic algorithm is a computerized search and optimization algorithm based upon mechanics of natural genetics and natural selection. In the principle of genetic algorithm, an initial population is created with a set of randomly generated feasible chromosomes. Each feasible chromosome is a solution of the optimization problem which may or may not be the optimal. The chromosomes in the population are then evaluated with a predefined objective function. The value of the objective function is called fitness value.

Two chromosomes are then selected based on their fitness values. Higher the fitness values higher the chance of being selected. Selected chromosomes (parents) then “reproduce” to create two offspring (children). By this procedure next generation (new population) is created. This is motivated by the possibility that the new population will be better than the old population.

This continues until a suitable solution has been found or a certain number of generations have passed, depending on the needs of the problem, successive generations tending toward an optimal solution.

A number of studies have been done to determine the optimal machining parameters. Genetic algorithm has been used to optimize material removal rate for multi-tool milling operations [Rai et al. 2009].

[Dereli et al. 2001] has disclosed optimized cutting parameters for milling operations taking unit cost as an objective function.

[Tondon et al. 2002] has developed method (based on evolutionary computation) to optimize machining time for two cutting parameters (spindle speed and feed rate).

[Shunmugam et al. 2000] has presented a method for optimal cutting parameters in multi-pass face milling which considering the technological constraints such as dimensional accuracy, surface finish and tool wear.

[Wang et al. 2004] has developed a method for optimize production time for multi-pass milling All the above mentioned studies did not consider the most important constraint of stability of milling process in their studies.

[Palanisamy et al. 2007] has developed GA optimization algorithm to maximize material removal rate while considering the stability of the milling process but their technique is limited in terms of design variables.

Most of the studies optimized fewer cutting parameters considering fewer constraints. Further, toolpath are assumed to be simply straight toolpath without consideration of convex pocket geometry. It is obvious that real optimal cutting parameters cannot be achieved without considering all cutting parameters (spindle speed, axial depth of cut, radial depth of cut and feed rate), constraints and toolpath simultaneously.

Patent publications in the field of the invention include the following documents US 2001/000805, JP 2005074569 A, JP 2005305595 A, JP 2006043836 A, US 2005/246052, U.S. Pat. No. 5,289,383, U.S. Pat. No. 6,745,100, US 2010/087949, WO 03/019454, U.S. Pat. No. 6,428,252, U.S. Pat. No. 6,591,158, US 2004/193308, U.S. Pat. No. 4,833,617, WO 2006/050409, US 2007/088456, US 2003/125828, US 2009/214312, US 2004/098147, US 2008/255684, US 2010/138018, WO 2008/118158, JP 2010003018, EP 1 225 494, U.S. Pat. No. 7,287,939, EP 1 048 400, EP 0 503 642, US 2007/085850.

### PRINCIPLE OF THE INVENTION

The present invention concerns a method having the following features:
Machine tool system dynamics (chatter vibrations) have been considered to guarantee the stable cutting process.
Machine tool constraints [limits of Power, torque and feed rate] and cuting tool specifications are considered.
Development of new toolpath generation method which minimizes the variation of radial depth of cut and avoids sharp corners along the toolpath.
Optimization method is developed to minimize the machining time by automatic selection of cutting parameters and corresponding toolpath.

More specifically, a new genetic algorithm (GA) based optimization method has been developed that allows a significant reduction of machining time in milling of convex pockets with regard to current available chatter free optimization methods.

The method according to the present invention relies on the following two sub-methods:

1. Toolpath generation and optimization for high speed milling:
A new method has been developed to generate pocket milling toolpath that minimize the radial depth of cut variations as well as the curvature change variations while avoiding leftover material at the corners. These toolpaths automatically avoid self-intersecting features usually encountered during the offsetting of pocket boundary. These toolpaths result in reduction in milling time for a given maximum acceptable radial depth of cut in comparison to conventional high-speed milling pocket toolpaths.

2. Cutting parameters selection for chatfree efficient milling of pockets:
A complete system for the minimization of machining time for high speed pocket milling is developed using genetic algorithm based optimization method. The system allows the free choice of the cutting parameters namely axial depth of cut, radial depth of cut, spindle speed and feed rate. The developed optimization method incorporates all the relevant milling constraints: milling stability constraint, cutting forces, machine-tool and cutting tool capabilities.

Both sub-methods are combined together to achieve the method of the invention.

The output of the complete method is optimal cutting parameters and the corresponding toolpath for high speed pocket milling

The present invention has in particular the following advantages:
Overall Cost Reduction
   Reduced Tooling Cost
      Tool breakage
      Tool wear
   Reduced Waste
      Number of trial cutting tests
      Part verification
   Reduced Resources
      Man power
      Energy saving, overheads . . .

In an embodiment the method of toolpath generation and cutting parameters optimization for high speed milling of a convex pocket, a first sub-method of generating a toolpath and a second sub-method of generating optimized chatfree cutting parameters using a genetic algorithm wherein the first sub-method generates milling toolpaths that minimize the radial depth of cut variations as well as the curvature change variations while avoiding leftover material at the corners, wherein said toolpaths automatically avoid self-intersecting features encountered during the offsetting of pocket boundary such that the said toolpaths result in reduction in milling time for a given maximum acceptable radial depth of cut and wherein the second sub-method allows the free choice of cutting parameters and optimizes the milling time and wherein the optimization method incorporates relevant milling constraints as milling stability constraint, cutting forces, machine-tool and cutting tool capabilities.

In an embodiment the toolpath generation sub-method uses the parameters of tool radius, stepover and parametric form of pocket boundary.

In an embodiment the successive toolpaths are defined iteratively.

In an embodiment as toolpaths a set of regular passes are defined with offsetting until the boundary of a pocket is reached and then a set of looping passes are defined for milling corners of the pocket.

In an embodiment the cutting parameters are defined as axial depth of cut, radial depth of cut, spindle speed and feed rate.

In an embodiment the method comprises the following steps:
for a given set of inputs, ranges of cutting parameters are defined,
said cutting parameters are coded into chromosomes in the shape of an array with binary bit string;
an initial population is created by generating random chromosomes;
each chromosome is tested for its feasibility with respect to various constraints of the system;
further generations are produced using an iterative loop with operators until a predetermined number of generations is reached;
the best chromosome in the last generation is selected as optimal solution.

In an embodiment the optimal solution is selected after 100 generations.

In an embodiment the genetic algorithms operators are reproduction, crossover and mutation.

In an embodiment for reproduction, a selection of the above-average chromosome from the current population is made and a mating pool is determined in a probabilistic manner, wherein the i^{th} chromosome in the population is selected with probability proportional to its fitness value, fᵢ, wherein a roulette wheel selection is used as a reproduction operator wherein a roulette wheel is created and divided into slots equal to the number of chromosomes in the population and the width of the slot is proportional to the fitness value of the chromosome.

In an embodiment elitism is used as an operator to pick a predefined number of chromosomes from a population and add them to the next population of a further generation.

In an embodiment for crossover, once the roulette wheel is created, two different chromosomes (parents) are selected to generate two offsprings (children), wherein a multi-point crossover operator is used with a random crossover site to give birth to the resulted offsprings, O1 and O2.

In an embodiment the crossover site is selected randomly from 1 to 5 for example.

In an embodiment for mutation the allele of the gene in a chromosome is interchanged; from Zero(0) to One(1) or vice versa and only feasible offsprings (chromosome) are taken in the next generation.

### DETAILED DESCRIPTION OF THE INVENTION

The present invention will be better understood from a detailed description of embodiments and from the drawings which show:

FIG. 1 illustrates an example of a pocket geometry;

FIG. 2 illustrates the cutting parameters required for pocket milling;

FIG. 3 illustrates an example of change in radial depth of cut along the toolpath;

FIG. 4 illustrates an example of a stability lobe diagram;

FIG. 5(a) illustrates conventional contour parallel toolpaths;

FIG. 5(b) illustrates toolpath according to the invention;

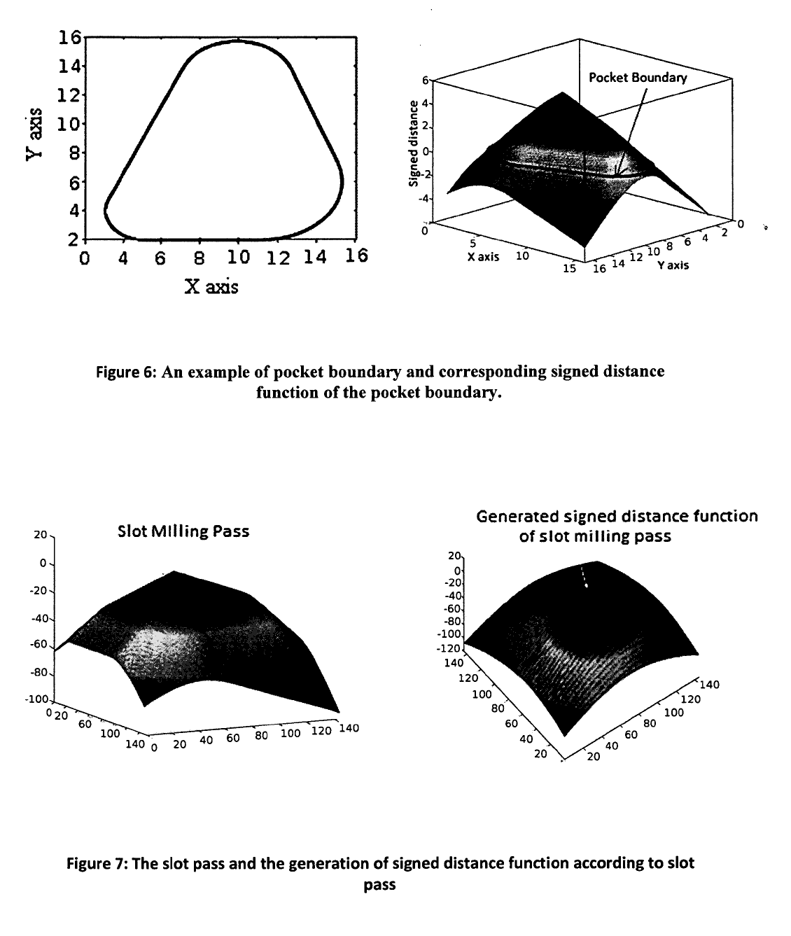

FIG. 6 illustrates an example of pocket boundary and corresponding signed distance function of the pocket boundary;

FIG. 7 illustrates the slot pass and the generation of signed distance function according to slot pass;

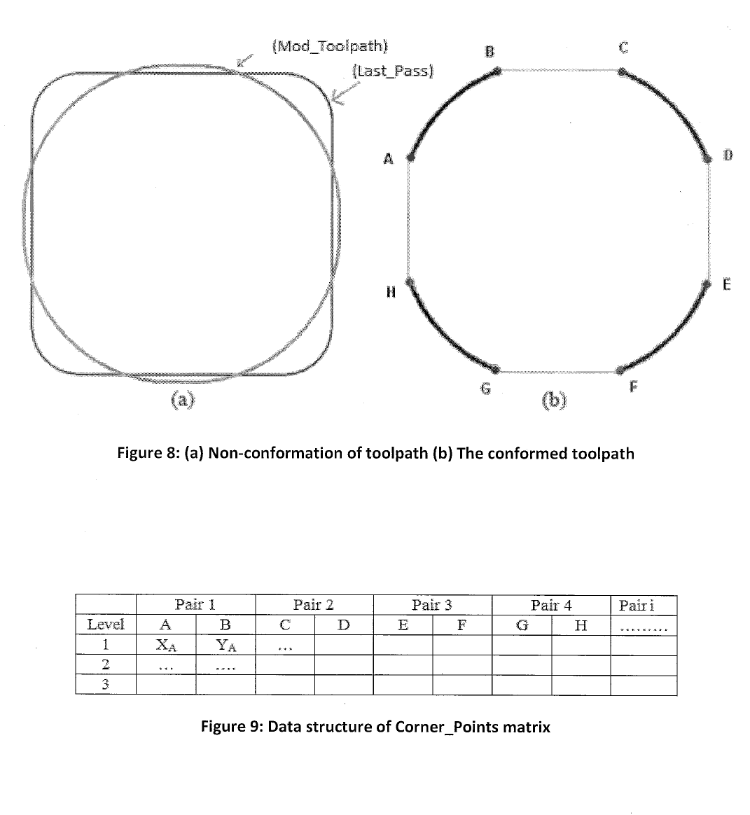

FIG. 8(a) illustrates a non-conformed toolpath and FIG. 8(b) illustrates a conformed toolpath;

FIG. 9 illustrates the Data structure of Corner_points matrix;

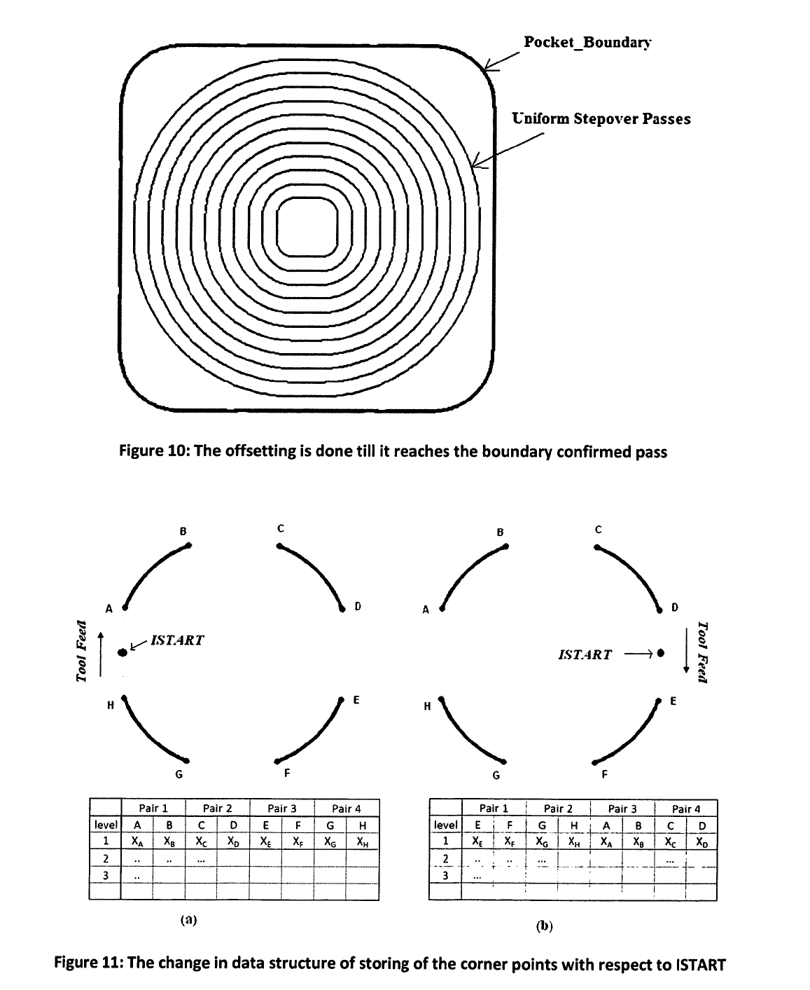

FIG. 10 illustrates the offsetting until it reaches the boundary confirmed pass;

FIGS. 11(a) and 11(b) illustrate the change in data structure;

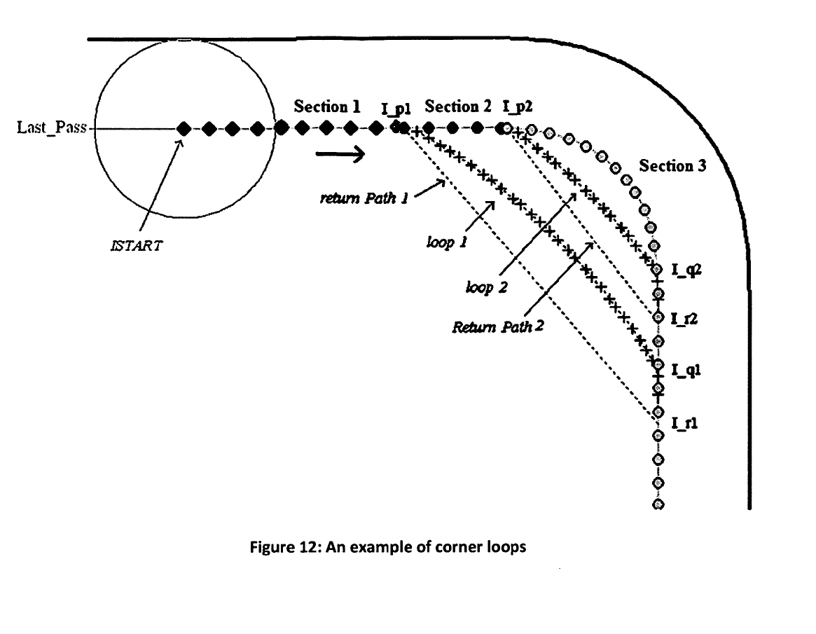

FIG. 12 illustrates an example of corner loops;

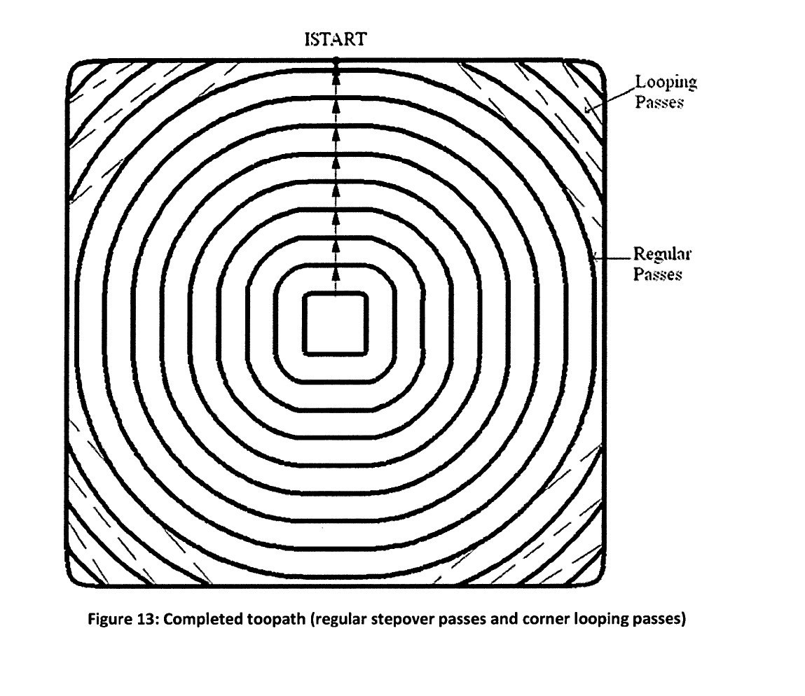

FIG. 13 illustrates the complete toolpath along with regular stepover passes and corner lopping passes

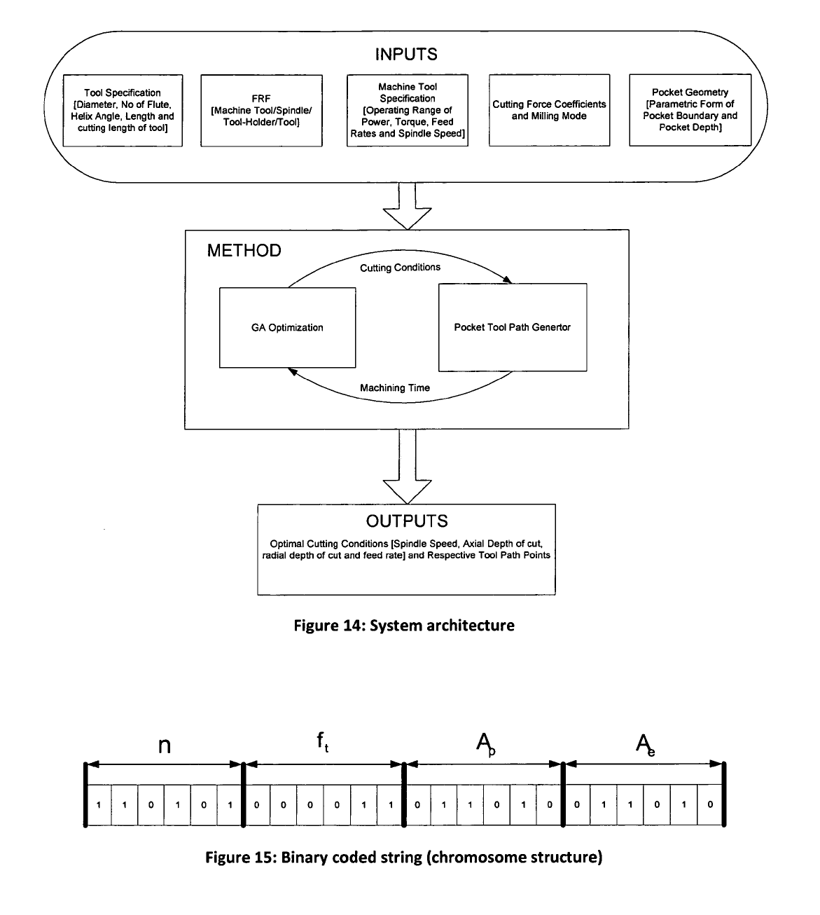

FIG. 14 illustrates a system architecture;

FIG. 15 illustrates a binary coded string;

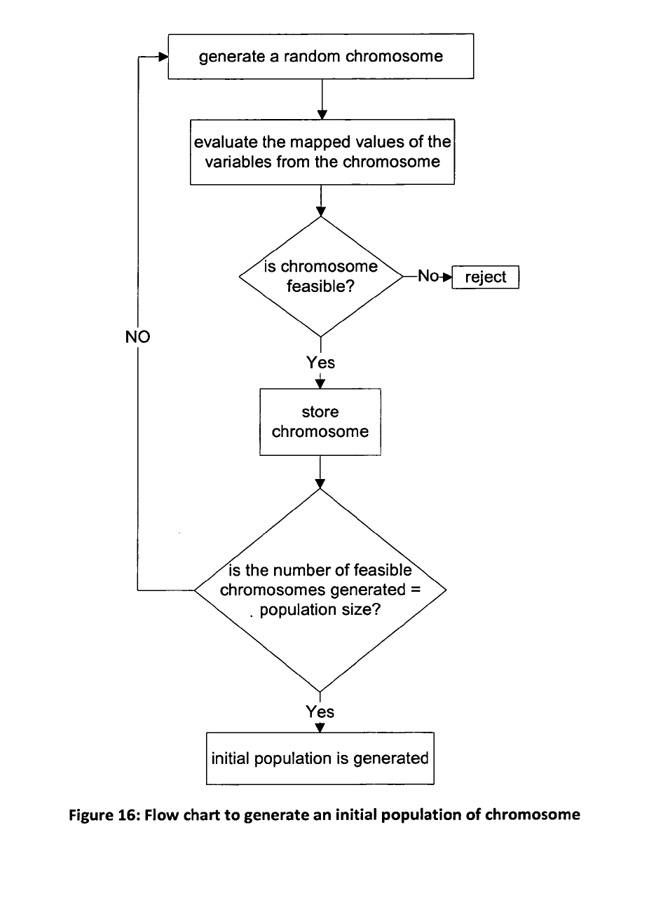

FIG. 16 illustrates a flow chart to generate an initial population of chromosome;

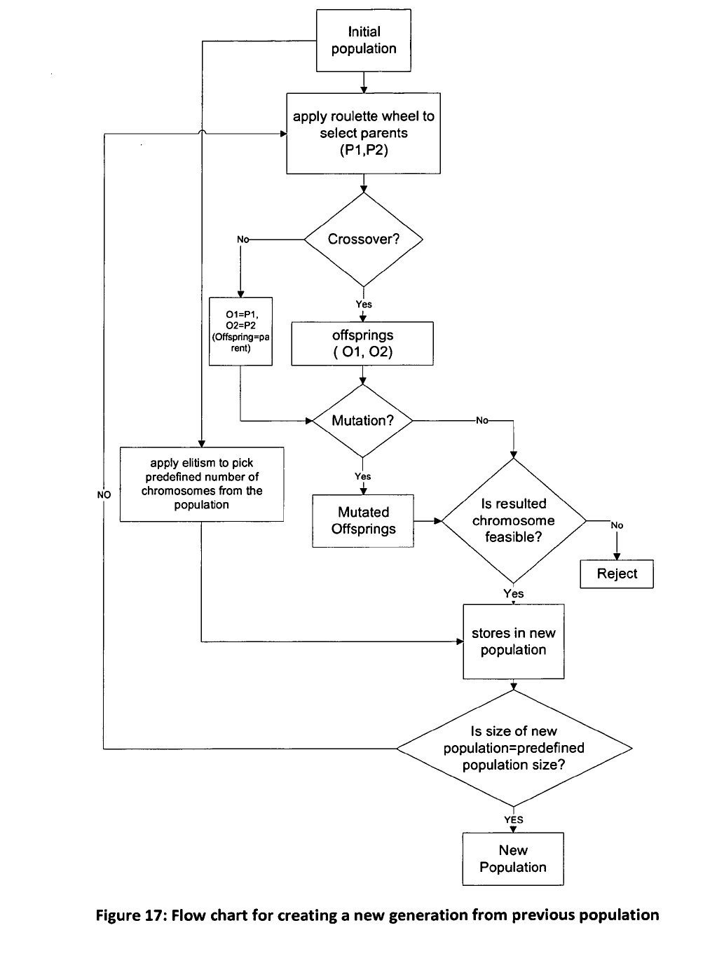

FIG. 17 illustrates a flow chart for creating a new generation from a previous population;

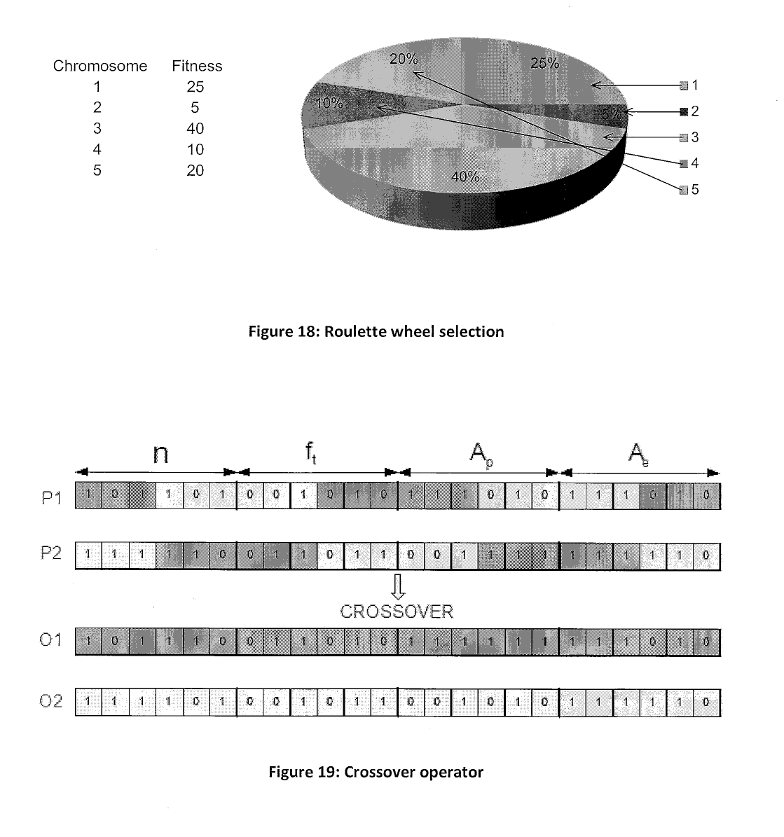

FIG. 18 illustrates a roulette wheel selection;

FIG. 19 illustrates a crossover operator;

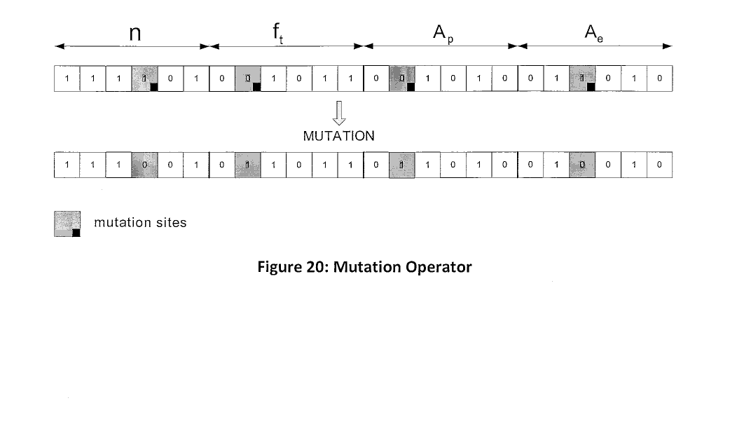

FIG. 20 illustrates a mutation operator and

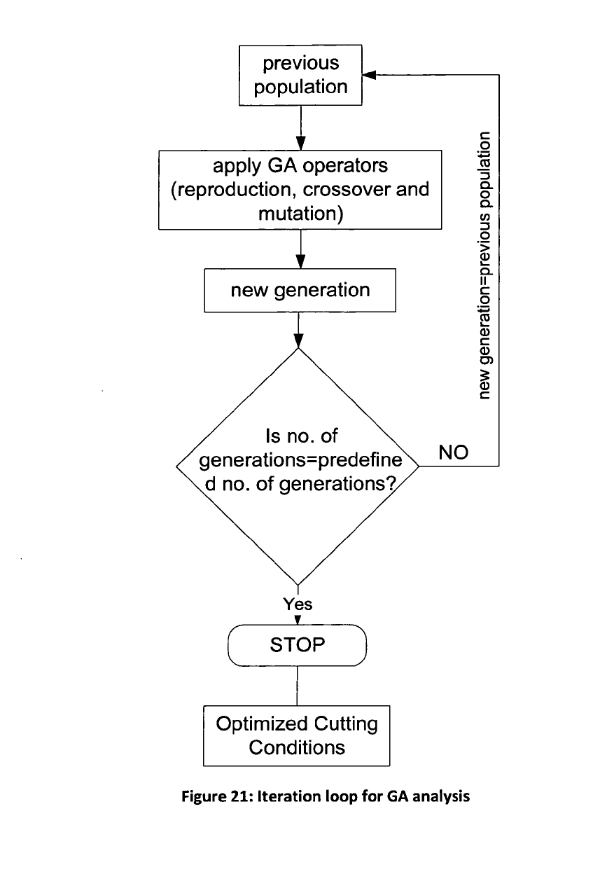

FIG. 21 illustrates an iteration loop for Genetic Algorithm analysis.

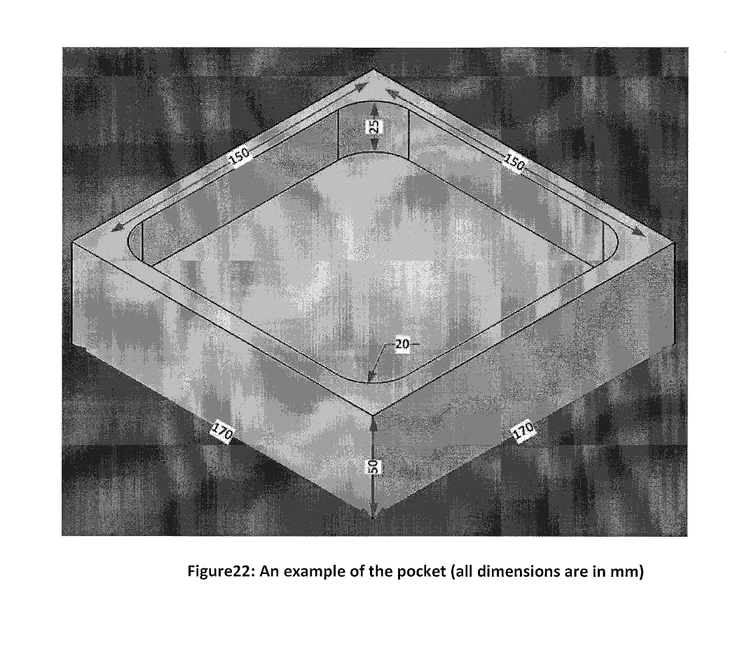

FIG. 22 illustrates an example of the pocket (all dimensions are in mm)

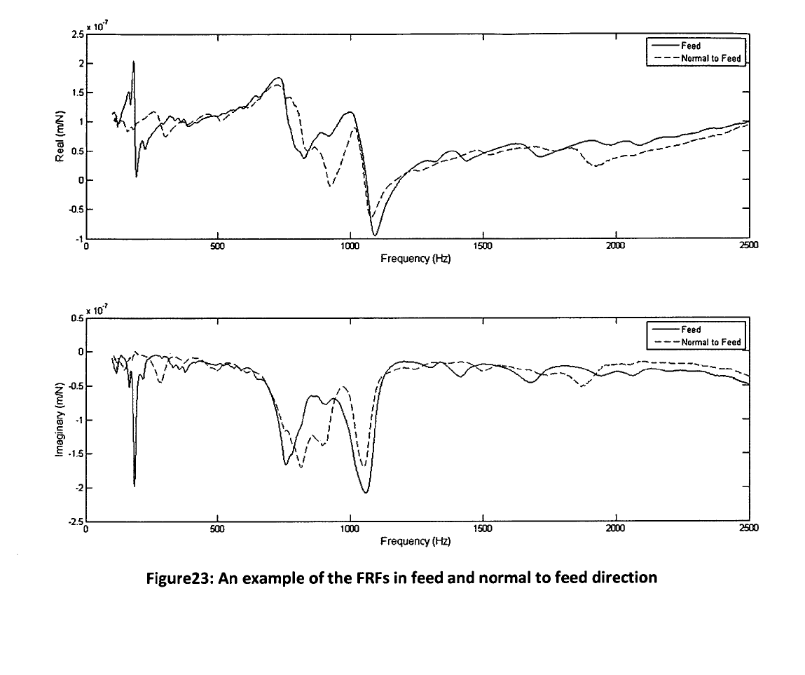

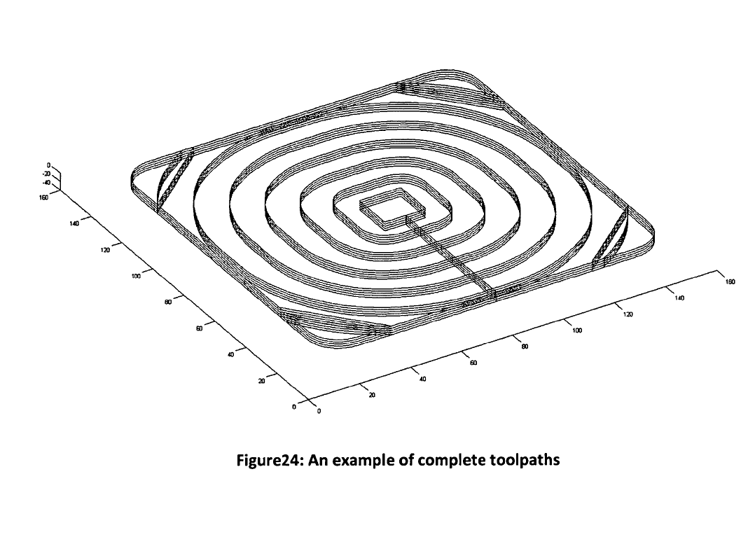

FIG. 23 illustrates an example of the FRFs in feed and normal to feed direction

FIG. 24 illustrates an example of complete toolpaths according to the present invention.

Method for Toolpath Generation
(i) Inputs: Parametric form of pocket boundary, Tool Radius and Stepover for the complete toolpath generation are used as inputs in the method for toolpath generation.
(ii) Using the Parametric form of pocket boundary, the arbitrary convex pocket boundary is initialized to signed distance function using fast marching method [Dhanik, 2010] cited hereunder, this publication being incorporated by reference in its entirety in the present application. This involves the domain of interest to be divided into rectangular grid points based on user specified grid distance. The grid points close to boundary within the length of one grid distance are initialized by travelling along the closed boundary. Using these grid points value as the known value, the partial differential equation is solved for distance value at neighboring unknown grid points are calculated. In this manner, the distance values of the unknown grid points are carried out until no grid point with unknown value is left. The output of this method is a matrix [Pocket_Boundary] of grid points. An example of this approach is given in FIG. 6. Toolpath at various levels can be extracted as the contour of the zero level set of signed distance function depending upon the radius of tool and the stepover distance. The toolpath matrix corresponding to the conforming to the boundary can be calculated as [Boundary_Conformed_Pass]=[Pocket_Boundary]−Tool_Radius
(iii) Next a contour is extracted as a slot milling pass from the top of signed distance function. Assuming this contour as a boundary, signed distance function of this boundary is again calculated using fast marching method [Dhanik, 2010] as shown as an example in FIG. 7. It is stored as [First_Pass]. An iterative method is then devised to extract other successive contours as shown in next steps.
(iv) Set local variable i=1 and set [Current_Pass]=[First_Pass]
(v) Extract the zero level contour from [Current_Pass] using the contour program and saved it as Modified_Tool_Path(i).
(vi) Set i=i+1.
(vii) Check for the intersection between the two signed distance functions, [Boundary_Conformed_Pass] and [Current_Pass]. The intersection condition specifies whether the toolpath is exceeding the pocket boundary, in such case it is needed to make the new toolpath to conform to the boundary of pocket. With the signed distance function this could be simply checked by a Boolean operation. First, calculate min([Boundary_Conformed_Pass],[Current_Pass]) and subtract it with [Current_Pass]. If the result produces a matrix with zero value at each data point, it means there is no intersection of the two signed distance functions, otherwise there is an interaction. If there is no intersection, go to step (viii) otherwise, go to step (ix).
(viii) [Current_Pass]=[Current_Pass]+Step_Over. Use the contour program to extract the zero level boundary and store it as Modified_Tool_Path(i). Go to step (vi).
(ix) In this step, [Current_Pass] is modified to conform to [Boundary_Conformed_Pass]. Again, the signed distance boolean operations are utilized to make quick calculations. [Current_Pass]=min([Current_Pass], [Boundary_Conformed_Pass]) gives the modified toolpath. As shown in FIG. 8, the Modified_Tool_Path(i) is crossing the zero level contour of [Boundary_Conformed_Pass] i.e. Last_Pass. Overwrite Modified_Tool_Path(i) by the zero level contour of [Current_Pass] (the modified toolpath for conforming to boundary pass) extracted by the contour program.
(x) The tool can move along the Modified_Tool_Path(i) but this will introduce a lot of idle sections (idle sections refers to cutting toolpaths involving no actual cutting action) in the toolpath, due to the fact that the inevitable boundary conformed pass (the zero level boundary of [Boundary_Conformed_Pass]). Note, however that the final shape of the pocket could be achieved. The corner points of the Modified_Tool_Path(i) denoted by points in FIG. 8(b) are determined simply by identifying the common points between the Modified_Tool_Path(i) and the zero level boundary of [Boundary_Conformed_Pass], they are the intersection points between the modified toolpath and the last pass (pocket boundary). Set level_CP=1 and go to step (xi).
(xi) If variable level_CP=1, an array is initialized to store the ordered list of coordinates of the corner points (for example, point A, B, C . . . H in FIG. 8(b)) and their level which is the respective toolpath in the corner points. The dimension of the array is set based on the number of pairs of corner points. This information is stored as Corner_Points(pair, level_CP). The data structure of this level is shown in FIG. 9. Each pair of points indicated by (I_p,I_q) can be accessed by calling the pair and level number Corner_Points(pair, level_CP) or [I_p,I_q]=Corner_Points(pair, level_CP). Note with reference to FIG. 8, I_p and I_q could be A, B, . . . H.
(xii) If variable level_CP=1, skip this step, otherwise store the points by checking that the intersection points are filled directly below the appropriate pair of points.
(xiii) This step is used to determine whether there is a need of further looping around a particular corner. [Current_Pass] is offset by a distance Step_over as: [Current_Pass]=[Current_Pass]+Step_over. Calculate min([Boundary_Conformed_Pass],[Current_Pass]) and subtract from [Current_Pass]. If the result produces a matrix with zero value at each data points, it means there is no intersection and go to step (xiv). Otherwise, set i=i+1 and set [Current_Pass]=min([Boundary_Conformed_Pass], [Current_Pass]), further create Modified_Tool_Path(i) as the zero level contour of the modified [Current_Pass]. Increment the level of Corner_Points Matrix as level_CP=level_CP+1, and go to step (xii).
(xiv) At this stage, all the uniform stepover without breaching the pocket boundary have already been determined. It is shown in FIG. 10 with the black lines “Uniform Stepover Passes”. The Output is Modified_Tool_Path(i) where i ∈ (1, n) where n refers to the number of passes, signed distance matrix [Boundary_Conformed_Pass], and Corner_Points.
(xv) Corner looping section (see FIGS. 11 and 12): Assuming the tool starts at some arbitrary point ISTART situated on the Last_Pass(Zero level contour of [Boundary_Conformed_Pass]), the tool travels to the point I_p1 and then instead of following the points of the Last_Pass, the tool follows the loop1 until I_q1. Loop 1 is the set of points in the Modified_Tool_Path(n-level_CP) between point I_p1 and I_q1. After that the machine tool comes back to the initial point I_p1 and the process continues. Here, two points should be clarified before developing the details of the algorithm First, the point ISTART can be chosen as an arbitrary point on the ordered point set of Last_Pass in the middle of two corners. Secondly, for a given ISTART, the position of the ISTART is first determined in comparison to the corner looping pair of Corner_Points(level_CP=1). For example, it is determined that point ISTART lies between which of the two corner pairs AB, CD, EF and GH in FIG. 8(b). The data structure of Corner_Points is then modified such that Pair1 refers to the corner pair it will approach first and Pain is the last visited corner. This concept is shown in FIGS. 11 and 12. Modifying the data structure in this way will help in handling the corner
(xvi) Set local variable i_loop=1 (i_loop refers to a pair number), j_loop=1 (refers to the level), set Path_start=ISTART, initialize an array CL_point as an empty array.
(xvii) Extract point [I_p, I_q]=Corner_Points(pair i_loop, level j_loop), if [I_p, I_q] is not empty matrix, go to next step. Otherwise, there are no more corners left for looping, hence go to step(h).
(xviii) Starting from the Path_start store Last_Pass points till the first point I_p to CL_Point in append mode. (Square shaped points in FIG. 12).
(xix) Append CL_Point to include the loop1 points. This is done by selecting the points of Modified_Tool_Path(n-level_CP+i_loop−1) between points I_p and I_q. Some extra points are also added beyond I_q just for illustration purposes in FIG. 12. Thus, the tool returns from the point I_r to I_p. The points of the Modified_Tool_Path(n-level_CP) between I_q and I_r are also appended in CL_Point.
(xx) For the returning path, as the interpolation between two points is assumed linear, the point referring to the end point of interpolation is appended to the list, which is point I_p. Set Path_start as I_p.
(xxi) Set j_loop=j_loop+1 and [I_p, I_q]=Corner_Points(pair i_loop, level j_loop), if [I_p, I_q] is not empty matrix, go to step (xviii), otherwise go to next step.
(xxii) Set i_loop=i_loop+1, and j_loop=1, check first that i_loop≦Maximum number of pairs (i.e. number of columns of Corner_Points matrix). If yes, go to step (xvii), otherwise go to step (xxiii)
(xxiii) Follow Last_Pass from Path_start to ISTART and store the points in CL_Point by appending the list.
(xxiv) The regular passes and the corner looping passes determined from the above method are combined in a manner as shown in FIG. 13 which summarizes the method for determining the toolpath according to the present invention.

For a given set of input parameters as described in FIG. 14 which illustrates the overall method of the invention in a block diagram, the abovementioned method “Method for Toolpath Generation” utilizes three parameters namely tool radius, stepover and parametric form of pocket geometry and thus generates the corresponding toolpath.

For a given input set of parameters, the parametric form of pocket geometry and the tool radius remain same during whole optimization phase, but the value of stepover (radial depth of cut) is provided by the method for chatter free optimization described hereunder. For each new value of stepover the corresponding toolpath is generated by the above described method and toolpath length is calculated. The toolpath length value is then returned to the method for chatter free optimization described hereunder. Accordingly, both sub-methods are linked together in the more general method of the present invention, as described herein.

Method for Chatter Free Optimization

Complete system architecture for the minimization of pocket milling is presented in FIG. 14. The details of the system are explained in the following paragraphs.

GA Initialization
1. For a given set of inputs cutting parameters, ranges (search space) of cutting parameters are defined. For example, radial depth of cut (Aₑ) range lies between 0 to tool diameter (D), axial depth of cut (Aₚ) lies between 0 to minimum of (cutting length of tool or depth of the pocket). Spindle speed (n) and feed rate (fₜ) ranges are selected from the machine tool system specifications or can be specified by the user.
2. To start with, cutting parameters are randomly coded in a single chromosome (an array) with binary bit string composed of zeros (0) and ones (1). Each cutting parameter is assigned with fixed number of bits see the reference [Rai et al. 2009] incorporated by reference in its entirety in the present application. An example of chromosome with bit size 6 per cutting parameter is presented in FIG. 15.
   As illustrated in FIG. 15, each cutting parameter is a quarter segment of coded binary string and represents a percentage value of the range of the parameters and is presented by:

$$X = ( \frac{{X}_{ma x} - {X}_{m i n}}{63} ) Y + {X}_{m i n}$$

Y is the decoded value of the respected segment. X is the mapped value of the cutting parameter Xmin and Xmax are the upper and lower bounds of the cutting parameter respectively.
For example the spindle speed range is 10000-20000 rpm and decoded value of the spindle speed is 53 (conversion of ‘110101’ to decimal point). The mapped value of the spindle speed will be 18412 rpm.
3. An initial population is created by generating random chromosomes. The feasibility of each chromosome is checked with various constraints such as machine tool system (machine tool/spindle/tool-holder/cutting tool) stability, cutting tool constraints like allowable cutting tool deflection and breaking strength, machine tool constraints like power and torque limits A feasible chromosome is one which respects all the constraints and is also a solution of the optimization problem which may or may not be the optimal. For each feasible chromosome the toolpath is generated using “method for toolpath generation” disclosed above. The corresponding toolpath length is calculated. Based on all cutting parameters total machining time is calculated. The minimization problem (“pocket milling time”) is converted to maximization problem (“fitness value”) and the fitness value (f) for a given chromosome is equated by:

$${T}_{mac} = \frac{ceil ( \frac{{D}_{p}}{{A}_{p}} ) * {L}_{toolpath} * 60}{{f}_{t} * N * n}$$

$$f = \frac{1}{( 1 + {T}_{mac} )}$$

Here T_{mac} represented the pocket milling time in seconds, Dₚ is the depth of the pocket in mm, Aₚ is the axial depth of cut in mm, ceil is the round-up function, Lₜₒₒₗₚₐₜₕ is the length of the generated toolpath at one axial level in mm, fₜ is the feed rate in mm/flute, N is the number of flutes of the cutting tool and n is the spindle speed in rpm. The steps involved for creating the initial population for GA analysis are presented in FIG. 16 as an iterative process.

GA Operators
4. After creating the initial population, a new generation (the next population) is produced using GA operators namely reproduction, crossover and mutation. The steps involved for creating the generation are presented in FIG. 17. The GA operators used in the developed method are explained in following paragraphs:
   Reproduction: Reproduction selects the above-average chromosome from the current population and makes the mating pool in a probabilistic manner. The i^{th} chromosome in the population is selected with probability proportional to its fitness value, fᵢ. The probability pᵢ for selecting the i^{th} chromosome is given by

$${p}_{i} = \frac{{f}_{i}}{{\sum }_{j = 1}^{n} {f}_{j}}$$

Here n is the population size. A roulette wheel selection is used as a reproduction operator. A roulette wheel is created and divided into slots equal to the number of chromosomes in the population. The width of the slot is proportional to the fitness value of the chromosome.
For example, roulette wheel for five chromosomes is given in FIG. 18. The slot width of first chromosome is calculated by 25/(25+5+40+10+20) and so on for each other chromosome. Thought it is clear from the roulette wheel selection that chromosomes with higher fitness values have greater chances of being selected for the mating pool than the chromosomes with a lesser fitness value but to ensure better chromosomes from previous population should not be lost during the reproduction, elitism may also be implemented in the method. In elitism a fixed number of chromosomes (with better fitness) are picked from the previous population and transferred as such in the next generation (new population).
Crossover: Once the roulette wheel is created, two different chromosomes (also called parents) are selected to generate two offsprings (also called children). The multi-point crossover operator is used in the present work. A predefined crossover probability is set for GA analysis (usually a high value, 60-100%). An example of crossover operator used for the analysis is shown in FIG. 19.
Parents P1 and P2 are selected for the crossover and the crossover site is found by generating a random number from 1 to 5. Multi-point crossover with random crossover site “3” (just an example) is shown in FIG. 19. The P1 and P2 are interchanged with their alleles (0 and 1) between crossover sites to give birth to the resulted offsprings, O1 and O2.
Mutation: To prevent the GA solution to fall in a local optimal value, a mutation operator is used. A predefined mutation probability is set for GA analysis (usually a small value, 0.1-20%). During mutation the allele of the gene is interchanged; this means Zero(0) is changed with One(1) and vice versa. For a given chromosome each gene (each bit has an independent chance, with the mutation probability, to mutate) is given a chance for mutation. The mutation operator used for the developed model is shown in FIG. 20. Only feasible mutated offsprings are taken in the next generation for further analysis, the feasible offspring being defined as the feasible chromosome above in the present description.

Using all the GA operators, a next generation (new population) is produced. GA analysis is an iterative loop and it will continue till the predefined number of generations is reached. The predefined number of generations is selected based upon convergence of the optimal solution. The steps involved are presented in FIG. 21.

The best chromosome in the final generation is the optimal solution. Optimal cutting parameters and corresponding toolpath using the radial depth of cut from the optimal cutting parameters are the outputs of the developed optimization system for pocket milling Of course, the present invention is not limited to the embodiments described above which are non-limiting examples. One may use variant and equivalents means or steps within the frame and scope of the present invention.

### EXAMPLE

The complete method is illustrated with a simple example:

Various Inputs:

1. An example pocket dimensions are presented in FIG. 22.

2. The specifications of the cutting tool are given in Table 1.

TABLE 1
An example of cutting tool specifications

| | | | | Cutting | |
|---|---|---|---|---|---|
| Diameter | Helix Angle | Rake Angle | | Length | Total Length |
| (mm) | (deg) | (mm) | Flutes | (mm) | (mm) |
| 16 | 40 | 25 | 3 | 92 | 32 |

3. For a combination of the work piece material and cutting tool specifications cutting force coefficients are given in Table 2.

TABLE 2
An example of cutting force coefficients

| Ktc | Krc | Kac | Kte | Kre | Kae |
|---|---|---|---|---|---|
| (N/mm²) | (N/mm²) | (N/mm²) | (N/mm) | (N/mm) | (N/mm) |
| 681 | 86 | 218 | 12 | 19 | 2 |

Where Ktc, Krc and Kac are the cutting coefficients contributed by the shearing action whereas Kte, Kre and Kae are the edge coefficients in tangential, radial and axial directions respectively (see reference Altintas 2000).

4. Frequency Response Function (FRF) of machine tool/spindle/tool holder/cutting tool system at tool tip in the feed and normal to feed direction is generally measured using hammer testing. The real and imaginary part of FRFs in feed and normal to feed direction are presented in FIG. 23.

5. The maximum spindle speed of the machine tool is 30000 rpm, axis accelerations up to 5 m/s2 and feed speeds up to 50 m/min. The rated power of the spindle is 12 kW.

Initialization and Implementation:

1. Various GA operators are defined based on optimization problem: for example:

Population Size: 20, Crossover probability: 90%, Mutation Probability: 10%, No of generations: 100.

2. GA parameters (cutting parameters) ranges are defined. For example:

Spindle Speed (10000-30000 rpm) and feed rate (0.1 mm/flute-0.2 mm/flute) are selected. Axial depth of cut: 0-25 mm [0-min(cutting length of the tool, pocket depth)], Radial depth of cut: 0-16 mm (selected from cutting tool diameter).

3. The randomly created set of cutting parameters is represented in the form of chromosome as shown in FIG. 15. Feasibility of the chromosomes is checked with various constraints calculated based on defined inputs. For each feasible chromosome the toolpath is generated using the developed “method for toolpath generation”. Fitness value of the objective function is calculated. Initial population is created using algorithm proposed in FIG. 16.

4. The next generation (the new population) is generated using various GA operators namely, reproduction, crossover and mutation as shown in FIG. 17. The global optimal solution is selected after 100 generations. For this optimization problem the near optimal cutting parameters are presented below:
Spindle Speed=24000 rpm,
Feed Rate=0.15 mm/flute,
Axial depth of cut=5 mm (5 axial levels),
Radial depth of cut=12.5 mm

An example of complete toolpath is shown in FIG. 24.

Of course, all the examples and values given above are only for illustrative purposes and should not be construed in a limiting manner. Different embodiments of the invention may be combined together according to circumstances. In addition, other embodiments, values and applications may be envisaged within the spirit and scope of the present invention, for example by using equivalent means or other values.

### REFERENCES (ALL INCORPORATED BY REFERENCE IN THE PRESENT APPLICATION)

Altintas, Y. and Budak, E., Analytical Prediction of Stability Lobes in Milling, CIRP Annals—Manufacturing Technology, 44, 3567-362 (1995)

Choy, H. S. and Chan, K. W., A corner-looping based tool path for pocket milling CAD Computer Aided Design, 35(2), 155-166 (2003)

Dereli, T., Filiz, I. H. and Baykasoglu, A., Optimizing cutting parameters in process planning of prismatic parts by using genetic algorithms, International Journal of Production Research, 39, 3303-3328 (2001)

Jitender Rai, Daniel Brand, Mohammed Slama and Paul Xirouchakis, Optimal selection of cutting parameters in multi-tool milling operations using genetic algorithm, International Journal of Production Research, iFirst, 1-24 (2009)

Glenn Coleman, Alan Diehl and Robert B. Patterson, US 2005/0246052 A1

Glenn Coleman and Evan C. Sherbrooke, US 2010/0087949 A1

Martin Held, VRONI: An engineering approach to the reliable and efficient computation of Voronoi diagrams of points and line segments, Computational Geometry, 18(2), 95-123 (2001)

Michael Brady Bieterman, Donald R. Sandstrom, U.S. Pat. No. 6,591,158 B1

Palanisamy, P., Rajendran, I. and Shanmugasundaram, S., Optimization of machining parameters using genetic algorithm and experimental validation for end-milling operations, International Journal of Advanced Manufacturing Technology, 32, 644-655 (2007)

Sandeep Dhanik and Paul Xirouchakis, Contour Parallel Milling Tool Path Generation for Arbitrary Pocket Shape Using a Fast Marching Method, International Journal of Advanced Manufacturing Technology, Volume 50, Numbers 9-12, 1101-1111 (2010)

Shunmugam, M. S., Bhaskara Reddy, S. V. and Narendran, T. T., Selection of optimal conditions in multi-pass face-milling using a genetic algorithm, International Journal of Machine Tools and Manufacture, 40, 401-414 (2000)

Tandon, V., El-Mounayri, H. and Kishawy, H., NC end milling optimization using evolutionary computation, International Journal of Machine Tools and Manufacture, 42, 595-605 (2002)

Wang, Z. G., Wong, Y. S. and Rahman, M., Optimisation of multi-pass milling using genetic algorithm and genetic simulated annealing, International Journal of Advanced Manufacturing Technology, 24, 727-732 (2004)

Zhao, Z. Y., Wang, C. Y., Zhou, H. M. and Qin, Z., Pocketing toolpath optimization for sharp corners. Journal of Materials Processing Technology, 192-193, 175-180 (2007)

Altintas, Y. (2000). Manufacturing Automation: Metal Cutting Mechanics, Machine Tool Vibrations, and CNC Design. Cambridge University Press.

1. A method of toolpath generation and cutting parameters optimization for high speed milling of a convex pocket, wherein said method comprises a first sub-method of generating a toolpath and a second sub-method of generating optimized chatfree cutting parameters using a genetic algorithm wherein
the first sub-method generates milling toolpaths that minimize the radial depth of cut variations as well as the curvature change variations while avoiding leftover material at the corners, wherein said toolpaths automatically avoid self-intersecting features encountered during the offsetting of pocket boundary such that the said toolpaths result in reduction in milling time for a given maximum acceptable radial depth of cut
and wherein
said second sub-method allows the free choice of cutting parameters and optimizes the milling time and wherein the optimization method incorporates relevant milling constraints as milling stability constraint, cutting forces, machine-tool and cutting tool capabilities.

2. The method of claim 1, wherein the toolpath generation sub-method uses the parameters of tool radius, stepover and parametric form of pocket boundary.

3. The method of claim 1, wherein the successive toolpaths are defined iteratively.

4. The method of claim 1, wherein as toolpaths a set of regular passes are defined with offsetting until the boundary of a pocket is reached and then a set of looping passes are defined for milling corners of the pocket.

5. The method as defined in claim 1, wherein the cutting parameters are defined as axial depth of cut, radial depth of cut, spindle speed and feed rate.

6. The method as defined in claim 5, comprising the following steps:
for a given set of inputs, ranges of cutting parameters are defined,
said cutting parameters are coded into chromosomes in the shape of an array with binary bit string;
an initial population is created by generating random chromosomes;
each chromosome is tested for its feasibility with respect to various constraints of the system;
further generations are produced using an iterative loop with operators until a predetermined number of generations is reached;
the best chromosome in the last generation is selected as optimal solution.

7. The method as defined in claim 6 wherein the optimal solution is selected after 100 generations.

8. The method as defined in claim 6, wherein the genetic algorithms operators are reproduction, crossover and mutation.

9. The method as defined in claim 6, wherein for reproduction, a selection of the above-average chromosome from the current population is made and a mating pool is determined in a probabilistic manner, wherein the ith chromosome in the population is selected with probability proportional to its fitness value, fi, wherein a roulette wheel selection is used as a reproduction operator wherein a roulette wheel is created and divided into slots equal to the number of chromosomes in the population and the width of the slot is proportional to the fitness value of the chromosome.

10. The method as defined in claim 6, wherein elitism is used as an operator to pick a predefined number of chromosomes from a population and add them to the next population of a further generation.

11. The method as defined in claim 9, wherein for crossover, once the roulette wheel is created, two different chromosomes (parents) are selected to generate two offsprings (children), wherein a multi-point crossover operator is used with a random crossover site to give birth to the resulted offsprings (O1 and O2).

12. The method as defined in claim 11, wherein the crossover site is selected randomly from 1 to 5.

13. The method as defined in claim 6, wherein for mutation the allele of the gene in a chromosome is interchanged; from Zero(0) to One(1) or vice versa and only feasible offsprings (chromosome) are taken in the next generation.
